(19) United States
(12) Patent Application Publication
(10) Pub. No.: US 2012/0154112 A1
(43) Pub. Date: Jun. 21, 2012

(54) Integrated On-line Door Control System with Wireless Credential Interface

(75) Inventors: Jeffrey S. Zingsheim, Franklin, WI (US); Nathan J. Gerner, Waukesha, WI (US)

(73) Assignee: Honeywell International Inc., Morristown, NJ (US)

(21) Appl. No.: 12/971,036

(22) Filed: Dec. 17, 2010

(51) Int. Cl. G08B 29/00

(52) U.S. Cl. 340/5.61

(57) ABSTRACT

An access control unit can receive door specifying credentials wirelessly. Received credentials can be processed and a determination made to permit access. The unit can also receive signals from similar units. The received signals can be retransmitted.

### FIELD

The invention pertains to door control systems. More particularly, the invention pertains to such systems where the access credential can be in wireless communication with one or more door control units.

### BACKGROUND

Typical hotels have battery-powered electronic door handles on every guest door. The Electronic Door Handles have integrated readers, Request-to-Exit and Door Open/Close inputs, and possibly LED indicators.

The hotel doors are generally located within close proximity to each other, since hotel rooms are generally small and narrow. The card readers deployed today can either be stand-alone or configured through a wireless connection to a host. If a wireless connection is used to configure the Electronic Door Handle, then additional infrastructure, such as wireless access points, needs to be added. The cards used in hotels are usually magnetic stripe cards, where the user must swipe the card at the door. This is sometimes done when the hotel guest has his/her hands full of luggage.

One known system has been disclosed and claimed in published US Patent Application No. 2010/0201479 published on Aug. 12, 2010, entitled “Integrated On-line Door Control System With Standardized Interfaces”. The '479 application is assigned to the assignee hereof and incorporated herein by reference.

Issues associated with known door control systems include: The wireless connection to the network requires additional infrastructure. The hotel guest may need to swipe a magnetic stripe card with his/her hands full, and, there currently is no mechanism for tracking guests through a hotel.

### BRIEF DESCRIPTION OF THE DRAWINGS

FIG. 1 is a block diagram of one embodiment of the invention;

FIGS. 2A-2C are diagrams which illustrate aspects of operation of the embodiment of FIG. 1;

FIGS. 3A-3C are diagrams which illustrate aspects of operation of another embodiment; and

FIG. 4 illustrates aspects of yet another embodiment.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with embodiments of the invention, a primary, or door frame coupler is located in the door frame, and is externally powered. It provides power and communicates with the secondary, or door coupler in the door. In accordance with the invention, the primary coupler also communicates wirelessly with other primary couplers on adjacent doors. This enables the primary couplers to create a wireless communication network back to the access control panel or host, and eliminates the need for ‘home run’ wiring.

The secondary coupler communicates with the door handle, which performs the input sensing, along with lock/output control. In one aspect of the present invention, the primary coupler also communicates wirelessly with key fobs, access cards and other wireless credentials which use the same protocol. This enables the card reader to reside in the Primary Coupler, and reduces the cost and complexity of door side electronics and door handle.

In another aspect of the invention, this architecture would enable the guests to approach the door and have the door automatically unlock, which reduces the cumbersome card swipe with arms full of luggage. Also, every access card may communicate with every door, so tracking people through the hotel would be possible. This would be useful to hotels in an emergency event, or simply to indicate to parents that their children are in the arcade or pool, and the hotels may charge for the service.

Advantageously, the primary coupler may be used as a wireless communications access point in a mesh network. This enables wireless communication back to the Access Panel or Host without the need to purchase additional wireless access points. It also eliminates the need for ‘home run’ wires and reduces installation cost, since the primary coupler may be powered from a local power source, and the need for long communication wires is thus eliminated.

Additionally, the primary coupler may be used as a credential reader if the credentials communicate with the same protocol (i.e., WiFi, Bluetooth, WiBree, WiMAX, ZigBee, etc.). This eliminates the need for an embedded reader in the door handle, which may be difficult to implement in some installations. It also reduces the complexity and cost of the door side control circuitry as well as eliminating a credential sensor or reader.

Various embodiments can include, using the frame side units as wireless access points, and routing the wireless data between the electronic door handles and the access, or control, panel. The frame side units can also include wireless readers, and can detect wireless credential data which can be sent to the access panel through a wired, or wireless connection. Additionally, the frame side units can act as both wireless access points and credential readers and route the credential data to the access panel. The primary coupler can also route data to the door side electronic door handle, which can be less complex.

Alternately, in other embodiments, the door side unit can include a wireless receiver to act as a wireless access point or credential reader. In another aspect of the invention, the door side unit can be powered through an electrified hinge, and function as a wireless access point

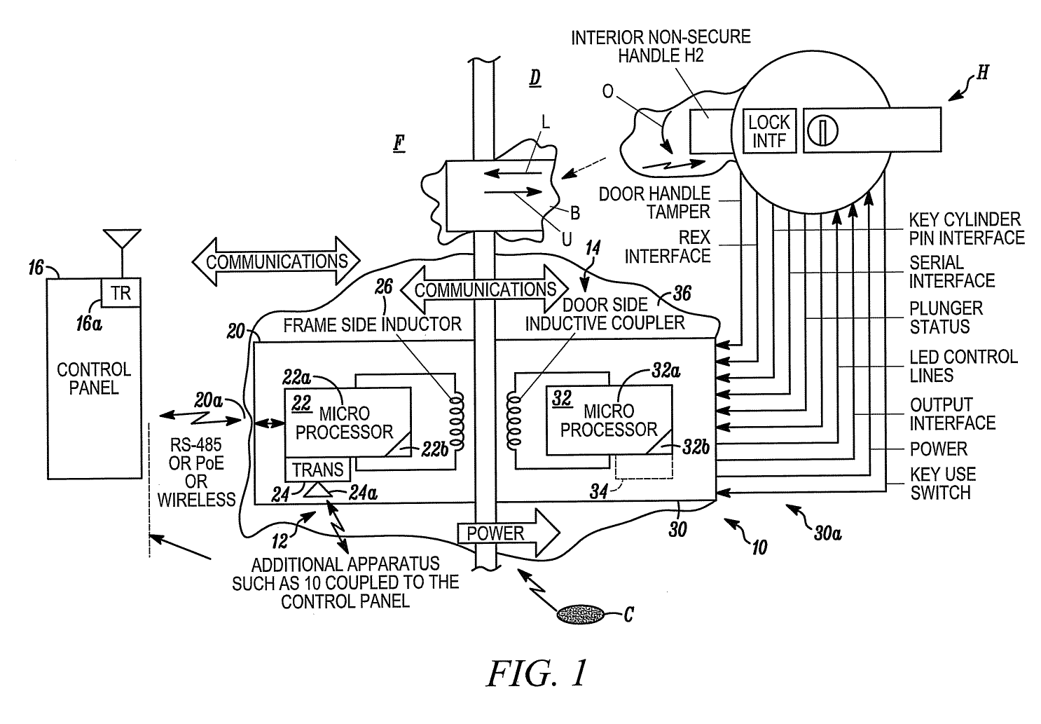

FIG. 1 illustrates a wireless door access control system which includes a plurality of door control units such as apparatus 10 which embodies the invention. The apparatus 10 is illustrated installed in a door frame F and in an associated door D. A handle H is coupled to the apparatus 10 as described below. Those of skill in the art will understand that apparatus 10 can be one member of a plurality of identical structures, each of which is installed on a different door.

The module 12 is in turn wirelessly coupled to a monitoring unit or control panel 16. Wired communications also come within the scope and spirit of the invention. Various communications protocols such as RS-485 could also be used without departing from the spirit and scope of the invention.

The frame side module 12 includes a housing 20 which carries an input/output port 20a, which can be coupled to a source of electrical energy, such as 60 Hz utility power. Housing 20 also carries control circuits 22. Circuits 22 could be implemented as a programmable processor 22a and associated control software 22b which would be stored on a computer readable medium, for example, semiconductor memory.

Module 12 can communicate wirelessly with the control panel 16, and to other control units, such as the unit 10, or receive credential information, from a wireless credential C, via a transceiver 24 and associated antenna 24a. Those of skill will understand that a variety of wireless communications protocols come within the spirit and scope of the invention and protocol details are not a limitation of the invention.

An inductor 26 is coupled to the circuits 22. Commands, and/or data can be wirelessly coupled from the control unit 16, or other units, corresponding to the unit 10, via the transceiver 24 to the control circuits 22. The inductor 26 can also couple commands, data and electrical energy to the door side module 14.

Door side module 14 includes a housing 30 which carries an input/output port(s) indicated generally at 30a. The housing 30 also carries control circuits 32 which could be implemented as a programmable processor 32a and associated control software 32b which would be stored on a computer readable storage medium, such as a semiconductor storage unit. The door side unit 32 can, in an alternate embodiment, include a transceiver 34, indicated in phantom. In this embodiment the unit 22 might be coupled via a network to the control panel 16.

A door side inductor 36 is also carried in housing 30. The inductor 36 can receive electrical energy from the frame side inductor 26 along with commands and/or data and couple same to the control circuits 32. As a result, no door battery is needed.

The module 14 can receive signals from and couple signals to the handle H as illustrated in FIG. 1. It will be understood that the input/output signals to the handle H are exemplary only.

In the embodiment of FIG. 1, the frame side control circuits 22 provide authorization, directly or via the control panel 16, through the inductors 26, 36 to unlock the bolt B from the frame F so that the door D can be opened. Handle H also carries a secure door opening handle H1 to retract bolt B in response to a credential being accepted by the apparatus 10, in combination with control panel 16. In this regard, the handle H includes a mechanical lock interface, shown in phantom, to enable handle H1 to engage the bolt B and move it in the direction U to unlock the door D under command of module 14 in response to a signal from the circuits 22.

Acceptance of a wireless credential C by control panel 16 can be in response to a bit stream being received from module 12 via the transceiver 24 at the control panel 16. Panel 16 can in turn determine that the subject credential C is an authorized credential for the door D and then transmit, to module 12 a door open command to be related to module 14. Module 14 can in turn generate an output to the lock interface which releases the handle H1 to retract the bolt B to open the door D.

Handle H can also carry an interior, non-secure handle H2 that a person in a region closed by the door D can use to generate a request exit REX signal to the module 14. The internal user can move handle H2 in direction O to generate the REX signal to module 14 and also mechanically retract the bold B in direction U to unlock the door D. Upon release of the handle H2, as the door D closes, the bold B can move in direction L to lock the door D closed against the door frame F.

Additionally, units 10 can provide credential tracking functions either directly to control panel 16 or via daisy chain-type transmissions between units 10 to the panel 16. Such tracking functions are discussed subsequently.

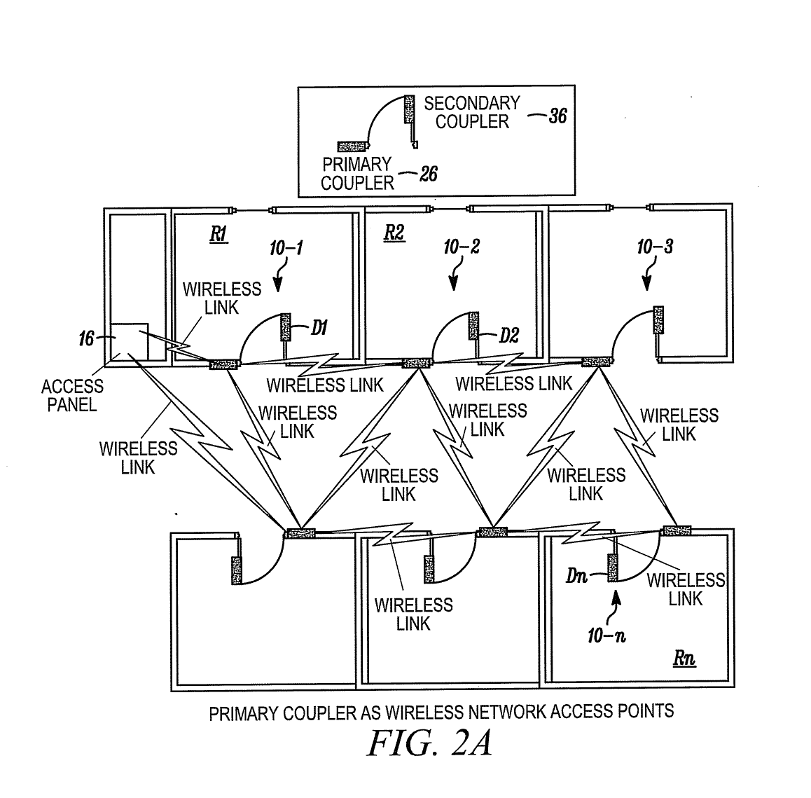

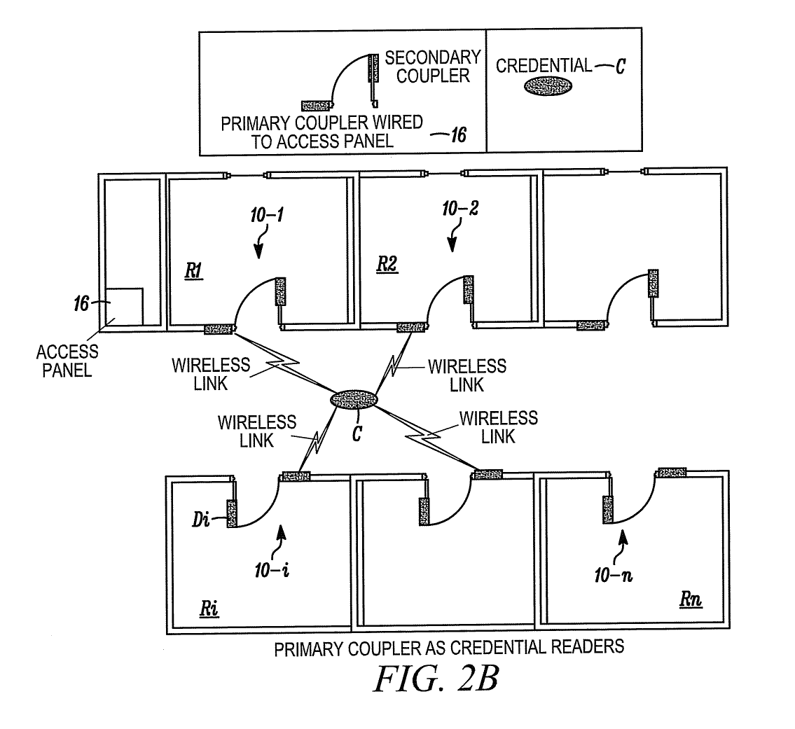

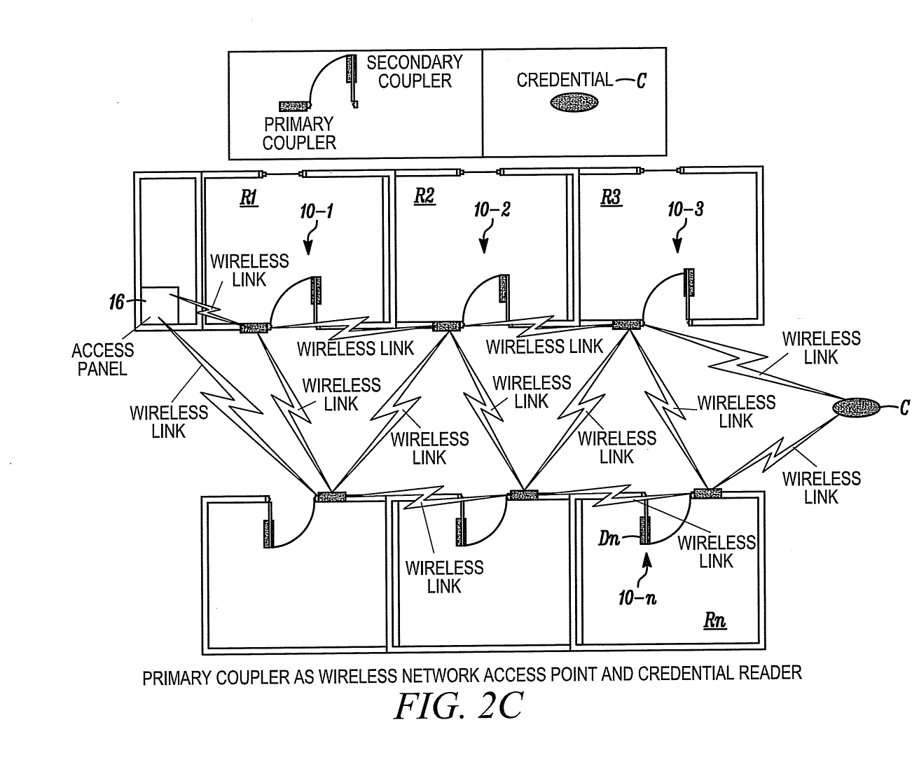

FIGS. 2A-2C illustrate various modes of operation of the system of FIG. 1. FIG. 2A illustrates a plurality of wireless links where the primary coupler, such as coupler 26, provides wireless access points at each of a plurality of rooms R1, R2 . . . Rm at a facility where the system has been installed. As illustrated in FIG. 2A, a given assembly, such as 10-I, need not be in direct communication with control unit 16. Instead, remote units, such as 10-n can communicate with the panel 16 via intervening units, such as 10-3, 10-2, and 10-1.

FIG. 2B illustrates aspects of system operation where the frame side circuitry 22 includes the transceiver 24 and is in wireless communication, at a variety of units 10-1, 10-2 . . . 10-I with credential C. Frame side circuitry, such as circuitry 22, receives, or transmits information from, to the wireless credential C which in one embodiment, as in FIG. 2B could be a door unlocking credential, or room “key”. The units 10-1 . . . 10-n could be coupled via a network to the panel 16. Access determinations can be made at the panel 16 or locally at the respective unit 10-i.

FIG. 2C illustrates an embodiment where the frame side circuitry 22 provides both wireless access points as well as credential reading.

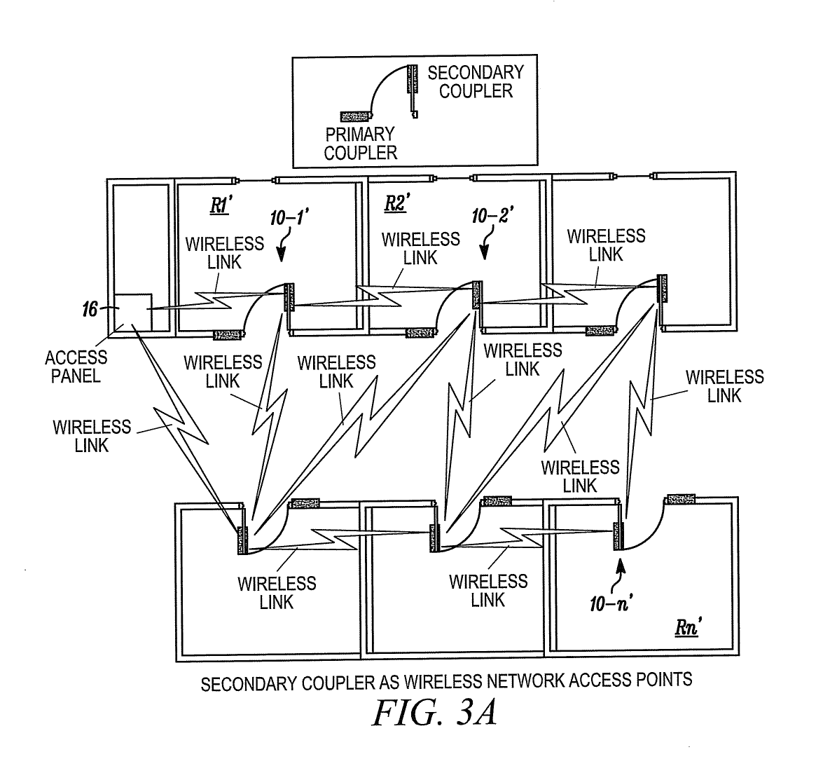

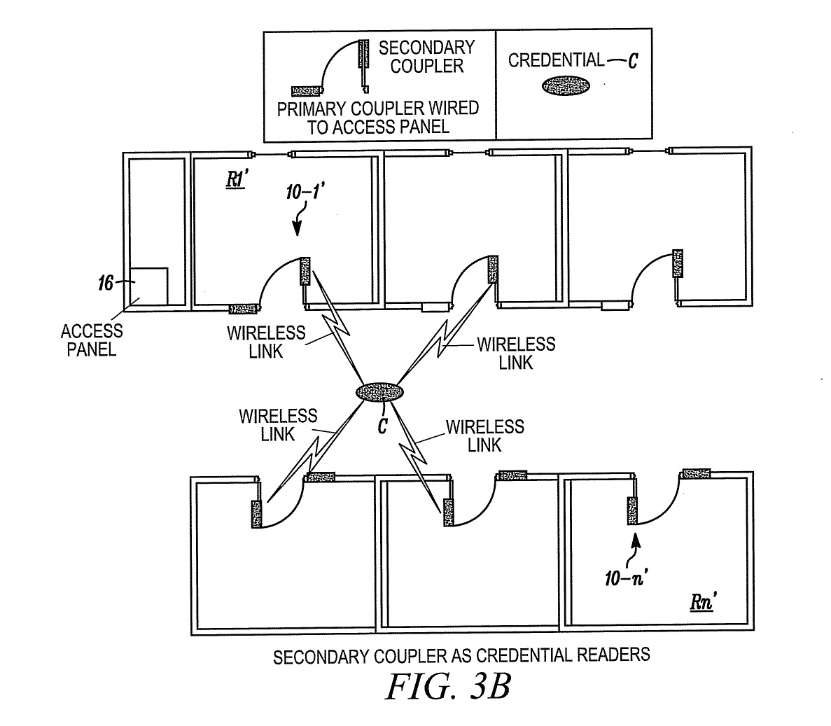

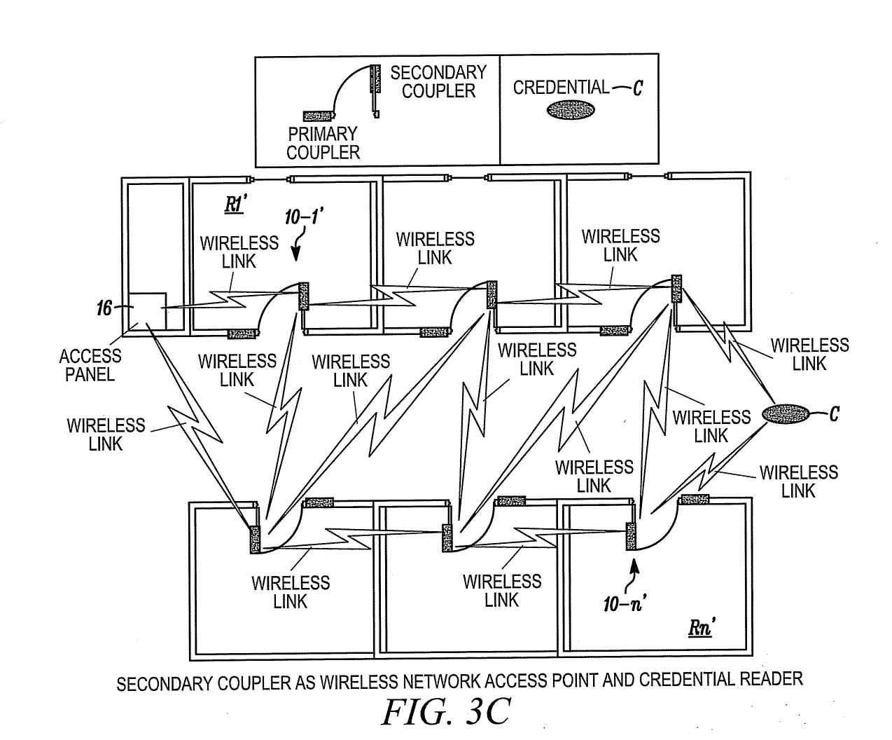

FIGS. 3A-3C illustrate access units, such as 10-I′ carry out comparable communications, as illustrated in FIGS. 2A-2C, where the door units such as the unit 14 includes the transceiver 34 and the frame side units, such as the unit 20 do not. In such circumstances the credential sensing also can take place via the transceiver 34 and the respective door side units.

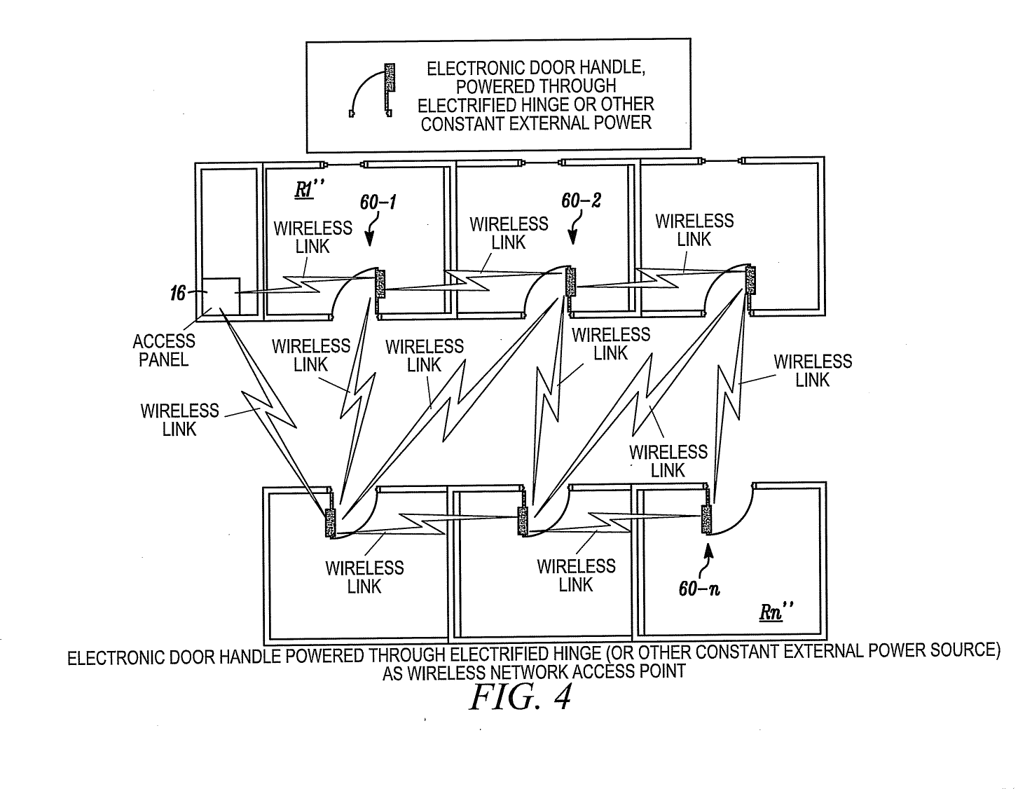

FIG. 4 illustrates an access control system with only door side units, such as 60-i where energy is provided to the units 60-i via an electrified hinge, or a local battery. In such embodiments, frame side unit 20 is not needed. All communications and processing can be carried out by the door side units, via the transceiver 34. The door side coupler 36 is not needed in this embodiment since the units 60-i are powered through the electrified hinge.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A modular access control apparatus comprising:
a door side module and a frame side module where the door side module includes a door housing, the door housing carries a door inductor coupled to door control circuits, the door housing also carries a door interface with the interface having a door latch control output and where the frame side module includes a frame housing, the frame housing carries a different inductor coupled to frame control circuits, the frame housing also carries a frame interface with at least one power port to couple electrical energy to the inductor and a transceiver coupled to one of the door side module or the frame side module where the transceiver receives at least one of a wireless credential input, or a transmission from another similar apparatus.

2. A system as in claim 1 where the wireless credential can be evaluated locally, or retransmitted to a displaced evaluator.

3. A system as in claim 1 where the received transmission from another similar apparatus can be retransmitted.

4. A system as in claim 1 wherein the door inductor couples electrical energy to and receives data signals from the door control circuits.

5. A system as in claim 4 wherein the door control circuits, responsive to signals from the door inductor, emit a door latch control signal to the door latch control output.

6. A system as in claim 4 where the door control circuits respond to a loss of electrical energy from the door inductor as indicative of a door open condition.

7. A system as in claim 6 where the door control circuits respond to a restoration of electrical energy from the door inductor as indicative of a door closed condition.

8. A system as in claim 1 where control circuits in one of the frame side module or the door side module retransmit the received transmission from another similar apparatus.

9. A system as in claim 8 where the frame inductor couples electrical energy to the door inductor.

10. A system as in claim 8 where the received wireless credential input is evaluated to determine if the door latch control output should be activated.

11. A system as in claim 10 where the wireless credential is evaluated locally or at a displaced location.

12. A system as in claim 1 where the frame inductor and the door inductor form an electro-magnetic transfer circuit when the inductors have a predetermined positional relationship relative to one another.

13. A system as in claim 12 where the electrical energy can be coupled from the frame inductor to the door inductor when the inductors exhibit the predetermined positional relationship relative to one another.

14. A door control apparatus comprising:
first and second separate housings, one housing is adapted to be mounted in a door and the other is adapted to be mounted in the vicinity of the door with each of the housings exhibiting at least one of an input port or an output port with at least one of the housings having a transceiver coupled to respective control circuits to receive and to process a wireless credential.

15. An apparatus as in claim 14 where in response to an acceptable credential, a door access control signal is generated.

16. An apparatus as in claim 14 where at least selected signals received at the transceiver are retransmitted.
